(19) United States
(12) Patent Application Publication
(10) Pub. No.: US 2024/0378768 A1
(43) Pub. Date: Nov. 14, 2024

(54) TECHNIQUES FOR GENERATING MATTES FOR IMAGES

(71) Applicant: NETFLIX, INC., Los Gatos, CA (US)

(72) Inventors: Paul E. DEBEVEC, Culver City, CA (US); Dmitriy SMIRNOV, Boston, MA (US); Xueming YU, Arcadia, CA (US); Chloe LEGENDRE, Culver City, CA (US)

(21) Appl. No.: 18/625,894

(22) Filed: Apr. 3, 2024

Related U.S. Application Data
(60) Provisional application No. 63/502,034, filed on May 12, 2023.

(51) Int. Cl. G06T 11/00; G06T 5/70; G06T 7/194

(52) U.S. Cl. CPC G06T 11/001; G06T 5/70; G06T 7/194; G06T 2207/10024; G06T 2207/20081

(57) ABSTRACT

In various embodiments, alpha channels are determined for images. In some embodiments, an image is captured using foreground lighting of a particular color and a background having a complement color. The image is pre-processed to correct for color crosstalk. The complement color in the pre-processed image is converted to grayscale to generate a holdout matte, which can be inverted to obtain the alpha channel (i.e., matte) that indicates pixels of the image belonging to the foreground and/or background. Bounce light is also removed by subtracting the bounce light, which can be determined during calibration, multiplied by the holdout matte. Then, a trained machine learning model can be applied to convert a foreground of the image having the particular color into a colorized foreground image that also includes the complement color. In addition, the image and corresponding alpha channel can be used to train a machine learning model to predict an alpha channel given an image.

### CROSS-REFERENCE TO RELATED APPLICATIONS

This application claims priority benefit of the United States Provisional Patent Application titled, “TECHNIQUES FOR SPECTRALLY AND/OR TEMPORALLY MULTIPLEXED ALPHA MATTING,” filed on May 12, 2023, and having Ser. No. 63/502,034. The subject matter of this related application is hereby incorporated herein by reference.

### BACKGROUND

### Field of the Invention

Embodiments of the present disclosure relate generally to image capture and processing, computer science, and machine learning and, more specifically, to techniques for generating mattes for images.

### Description of the Related Art

Oftentimes, when generating visual effects, the foreground of an image needs to be separated from the background of that image. For example, in a situation where a video frame of image data includes an actor in the foreground in front of a particular background, the foreground that includes the actor may need to be separated from the background in order to generate a desired visual effect involving the actor. Continuing with this particular example, once separated, the foreground that includes the actor can be composited with a different background to generate a composite video frame in which the actor appears to be at a different location.

Separating the foreground of an image from the background of the image is, as a general matter, quite challenging technically because each pixel of the image can belong to both the foreground and the background. For example, a given pixel can belong in part to the foreground and in part to the background when that pixel is at the edge of an object, part of a wispy or transparent structure, or within a defocused or motion-blurred area of the image, to name a few. Image data indicating whether each pixel in an image belongs to the foreground or background by a degree of opacity or transparency for each pixel is commonly referred to as the “alpha channel” and also is sometimes referred to as a “matte” or an “alpha matte.” The alpha channel can account for foreground pixels, background pixels, and pixels that belong to both the foreground and background. In this regard, the alpha channel can indicate that foreground pixels within an image are opaque, background pixels are transparent, and pixels belonging to both the foreground and background are semi-transparent.

One conventional approach for generating an alpha matte is to capture an image of a subject, such as an actor, in front of a green screen. Green pixels within the captured image are considered the background of the image for an alpha matte. One drawback of this approach is the green screen background is oftentimes not perfectly green (i.e., captured pixels of the green screen can have nonzero red and/or blue values), and foreground elements can also include green (i.e., captured pixels of the foreground can have nonzero green values). Consequently, the foreground can be difficult to disambiguate from the background, and a complex matting algorithm typically has to be used to generate an alpha matte that indicates pixels belonging to the foreground and the background. As a general matter, conventional matting algorithms have many parameters that need to be tuned manually for any given image. Accordingly, having to implement conventional matting algorithms is usually computationally complex, tedious, and labor-intensive.

Another conventional approach for generating a matte is to directly capture the matte using a second camera that captures a different type of light than is captured using an RGB (red, green, blue) camera. For example, a beam splitter can be used to split incoming light between the RGB camera and the second camera, and the second camera can include a filter to capture infrared (IR) or sodium vapor light that is used to distinguish the background from the foreground of an image. One drawback of this approach is that the images captured using the second camera need to be precisely aligned with images that are captured using the RGB camera, which is oftentimes difficult to achieve. In addition, any camera setup that includes a second camera is necessarily more cumbersome and more difficult from an operational perspective relative to using only an RGB camera.

As the foregoing illustrates, what is needed in the art are more effective techniques for generating alpha mattes for images.

### SUMMARY OF THE EMBODIMENTS

One embodiment of the present disclosure sets forth a computer-implemented method for generating mattes for images. The method includes receiving an image that includes a foreground having a first color and a background having a second color, wherein the second color is a complement of the first color. The method further includes generating a matte based on the second color included in the image.

Another embodiment of the present disclosure sets forth a system. The system includes at least one first light source configured to emit light having a first color. The system further includes a background having a second color that is a complement of the first color. In addition, the system includes a camera configured to capture at least a portion of the background and at least a portion of one or more objects illuminated by the at least one first light source.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques can be used to generate relatively high quality mattes for images, without requiring the use of any complex matting algorithms or requiring the manual tuning of any algorithm parameters. Accordingly, the disclosed techniques can be more computationally efficient and less labor intensive than prior art approaches. In addition, the disclosed techniques utilize images captured by a single camera rather than images captured by two separate cameras where the resulting images need to be precisely aligned with each other. Thus, the disclosed techniques can be more accurate and can generate images without artifacts resulting from misalignments relative to what can be achieved using prior art approaches. These technical advantages represent one or more technological improvements over prior art approaches.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a top-down view of a system for capturing images, according to various embodiments;

FIG. 2 illustrates a system configured to implement one or more aspects of the various embodiments;

FIG. 3 is a more detailed illustration of the compositing application of FIG. 2, according to various embodiments;

FIG. 4 is a more detailed illustration of the alpha channel module of FIG. 3, according to various embodiments;

FIG. 5 illustrates exemplar time-multiplexed video frames, according to various embodiments;

FIG. 6 is a more detailed illustration of the model trainer of FIG. 1, according to various embodiments;

FIG. 7A illustrates a machine learning model that colorizes mattes, according to various embodiments;

FIG. 7B illustrates exemplar composite images generated using the holdout mattes of FIG. 7A, according to various embodiments;

FIG. 8 is a flow diagram of method steps for generating a matte, according to various embodiments;

FIG. 9 is a flow diagram of method steps for generating a composite image, according to various embodiments;

FIG. 10 is a flow diagram of method steps for training a colorization model, according to various embodiments; and

FIG. 11 is a flow diagram of method steps for training a machine learning model to generate mattes for images, according to various embodiments.

### DETAILED DESCRIPTION

As described, separating the foreground of an image from the background of the image is, as a general matter, quite challenging technically because each pixel of the image can belong to both the foreground and the background. One conventional approach for generating an alpha matte is to capture an image of a subject, such as an actor, in front of a green screen. Green pixels within the captured image are considered the background of the image for an alpha matte. However, the green screen background is oftentimes not perfectly green, and foreground elements can also include green. Because the foreground can be difficult to disambiguate from the background, a complex matting algorithm typically has to be used to generate an alpha matte that indicates pixels belonging to the foreground and the background. As a general matter, conventional matting algorithms have many parameters that need to be tuned manually for any given image. Accordingly, having to implement conventional matting algorithms is usually computationally complex, tedious, and labor-intensive. Another conventional approach for generating a matte is to directly capture the matte using a second camera that captures a different type of light than is captured using an RGB (red, green, blue) camera. However, images captured using the second camera need to be precisely aligned with images that are captured using the RGB camera, which is oftentimes difficult to achieve. In addition, any camera setup that includes a second camera is necessarily more cumbersome and more difficult from an operational perspective relative to using only an RGB camera.

The disclosed techniques determine alpha channels for images. In some embodiments, an image, which can be a standalone image or a frame of a video, is captured using foreground lighting of a particular color and a background having a complement color. The image is pre-processed to correct for color crosstalk. The complement color in the pre-processed image is converted to grayscale to generate a holdout matte, which can be inverted to obtain the alpha channel (i.e., matte) that indicates pixels of the image belonging to the foreground and/or background. Bounce light is also removed by subtracting the bounce light, which can be determined during calibration, multiplied by the holdout matte. Then, a trained machine learning model can be applied to convert a foreground of the image having the particular color into a colorized foreground image that also includes the complement color. The colorized foreground image can then be composited with an image of another background. In addition, the image and corresponding alpha channel can be used to train a machine learning model to predict an alpha channel given an image.

Advantageously, the disclosed techniques can be used to generate relatively high quality mattes for images, without requiring the use of any complex matting algorithms or requiring the manual tuning of any algorithm parameters. Accordingly, the disclosed techniques can be more computationally efficient and less labor intensive than prior art approaches. In addition, the disclosed techniques utilize images captured by a single camera rather than images captured by two separate cameras where the resulting images need to be precisely aligned with each other. Thus, the disclosed techniques can be more accurate and can generate images without artifacts resulting from misalignments relative to what can be achieved using prior art approaches.

### System Overview

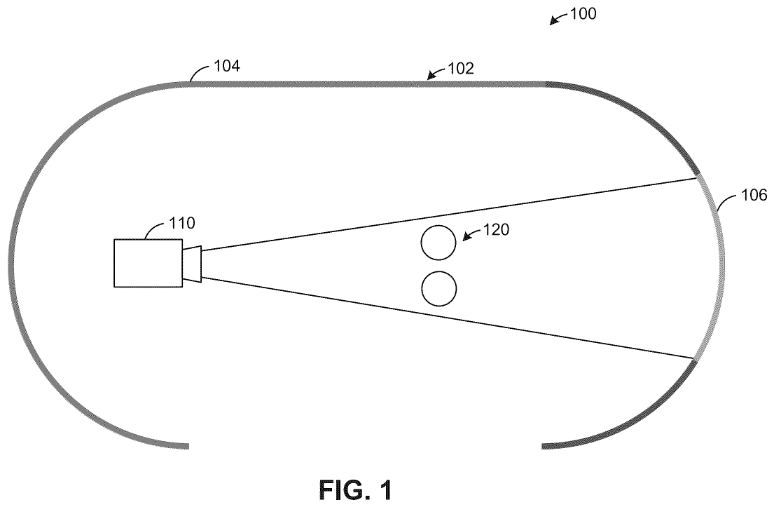

FIG. 1 illustrates a top-down view of a system 200 for capturing images, according to various embodiments. As shown, the system 200 includes foreground lighting 104, a background 106, and a camera 110 that is configured to capture images of objects 120 (e.g., actors) in front of the background 106. The images can be standalone images or frames of a video. Although two objects 120 are shown for illustrative purposes, any number of objects can be captured in some embodiments. Illustratively, the foreground lighting 104 and the background 106 are implemented using a light emitting diode (LED) volume 102 that surrounds the objects 120 with 270 degrees of LED panels, each of which includes red, green, and blue LEDs. In some embodiments, the LED panels can generate color saturated light of specific colors. In some other embodiments, foreground lighting and a background can be provided in any technically feasible manner. For example, rather than LED panels, the background could be a green screen that is lit by a light source.

Illustratively, in the LED volume 102, walls of the LED volume 102 in front and to the side of the objects 120 are used for the foreground lighting 104, and an area of the wall of the LED volume 102 behind the objects 120 is used for the background 106. In some embodiments, the background 106 can be within, and cropped tightly around, the camera frustum of the camera 110, to minimize spill light.

In operation, the camera 110 captures images of the objects 120 that are (1) lit by the foreground lighting 104 of one color, shown as magenta; and (2) in front of the background 106 that is a complement color of the foreground color, shown as green. Any suitable color and complement color can be used in some embodiments, such as yellow foreground lighting and a blue background, cyan foreground lighting and a red background, etc. Further, the camera 110 can be any suitable digital camera, such as a camera that is typically used for digital filmmaking.

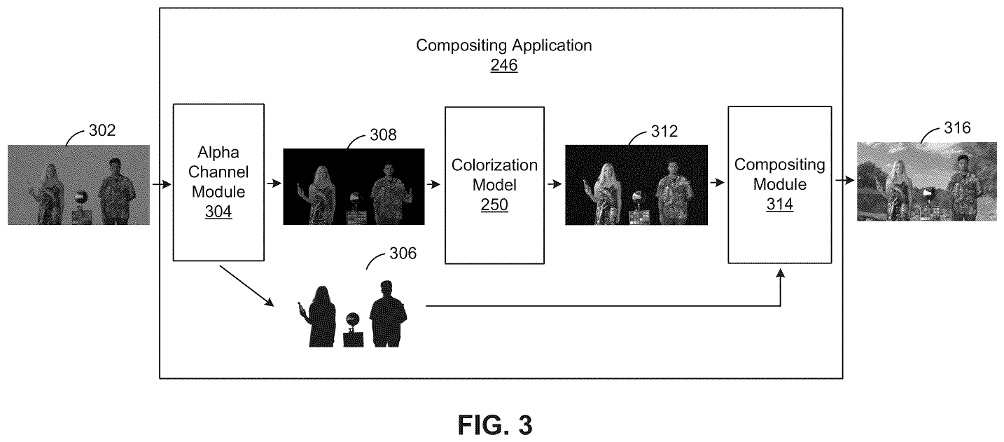

As described in greater below in conjunction with FIGS. 3-11, the complement color (e.g., green) of the background in the captured images can be used to obtain relatively high quality alpha channels for the captured images, because the complement color shows the objects 120 silhouetted against a bright, even background, that can be used directly as holdout mattes that are the inverse of the alpha channels for the captured images. Further, although the foreground does not include the complement color, a trained colorization model can be applied to generate an image of the foreground that does include the complement color.

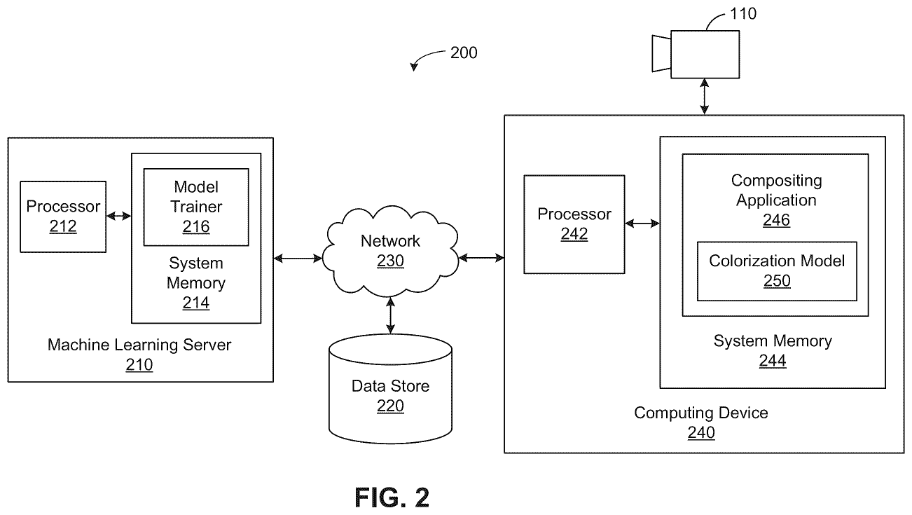

FIG. 2 illustrates a system configured to implement one or more aspects of the various embodiments. As shown, the system 200 includes a machine learning server 210, a data store 220, and a computing device 240 in communication over a network 230, which may be a wide area network (WAN) such as the Internet, a local area network (LAN), or any other suitable network.

As shown, a model trainer 216 executes on a processor 212 of the machine learning server 210 and is stored in a system memory 214 of the machine learning server 210. The processor 212 receives user input from input devices, such as a keyboard, a mouse, a joystick, a touchpad, or a touchscreen. In operation, the processor 212 is the master processor of the machine learning server 210, controlling and coordinating operations of other system components. In particular, the processor 212 may issue commands that control the operation of a graphics processing unit (GPU) that incorporates circuitry optimized for graphics and video processing, including, for example, video output circuitry. The GPU may deliver pixels to a display device that may be any conventional cathode ray tube, liquid crystal display, light-emitting diode display, or the like.

The memory 214 of the machine learning server 210 stores content, such as software applications and data, for use by the processor 212 and the GPU. The memory 214 may be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) may supplement or replace the memory 214. The storage may include any number and type of external memories that are accessible to the processor 212 and/or the GPU. For example, and without limitation, the storage may include a Secure Digital Card, an external Flash memory, a portable compact disc read-only memory (CD-ROM), an optical storage device, a magnetic storage device, or any suitable combination of the foregoing.

It will be appreciated that the machine learning server 210 shown herein is illustrative and that variations and modifications are possible. For example, the number of processors 212, the number of GPUs, the number of system memories 214, and the number of applications included in the memory 214 may be modified as desired. Further, the connection topology between the various units in FIG. 1 may be modified as desired. In some embodiments, any combination of the processor 212, the memory 214, and a GPU may be replaced with any type of virtual computing system, distributed computing system, or cloud computing environment, such as a public, private, or a hybrid cloud.

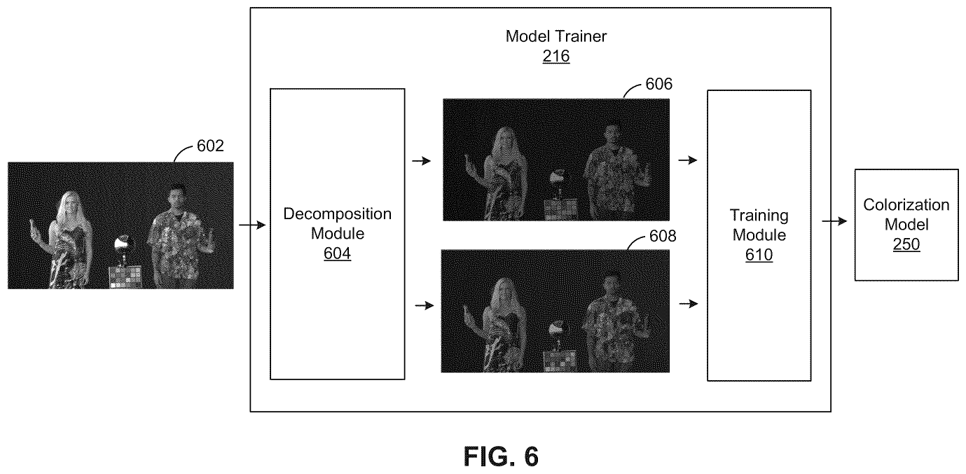

As discussed in greater detail below, the model trainer 216 is configured to train machine learning models, including a colorization model 250, as discussed in greater detail below in conjunction with FIGS. 6, 7A-7B, and 10-11. Training data and/or trained machine learning models, including the colorization model 250, can be stored in the data store 220 or elsewhere. In some embodiments, the data store 220 can include any storage device or devices, such as fixed disc drive(s), flash drive(s), optical storage, network attached storage (NAS), and/or a storage area-network (SAN). Although shown as accessible over the network 230, in some embodiments the machine learning server 210 may include the data store 220.

Subsequent to training, the trained machine learning models can be deployed to any suitable applications. Illustratively, a compositing application 246 that utilizes the colorization model 250 is stored in a memory 244, and executes on a processor 242, of the computing device 240. In some embodiments, the compositing application 246 determines alpha channels for images captured by the camera 110 of the system 100, described above in conjunction with FIG. 1, and the compositing application 246 can also composite the foregrounds of such images with other backgrounds using the alpha channels. The compositing application 246 is discussed in greater detail below in conjunction with FIGS. 3-5 and 7-9. In some embodiments, components of the computing device 240, including the memory 244 and the processor 242, can be similar to corresponding components of the machine learning server 210, described above.

The number of machine learning servers and computing devices may be modified as desired in some embodiments. Further, the functionality included in any of the applications may be divided across any number of applications or other software that are stored and executed via any number of devices that are located in any number of physical locations.

### Generating Mattes for Images

FIG. 3 is a more detailed illustration of the compositing application 246 of FIG. 2, according to various embodiments. As shown, the compositing application 246 includes an alpha channel module 304, the colorization model 250, and a compositing module 314. In operation, the compositing application 246 receives an image 302 as input. The image 302 can be a standalone image of a frame of a video that includes multiple video frames. In some embodiments, the image 302 can be captured using the system 100 described above in conjunction with FIG. 1. The compositing application 246 processes the image 302 to generate a composite image 316 that includes foreground objects from the image 302 and a different background than the image 302.

As shown, the image 302 includes a magenta foreground and a green background. The alpha channel module 304 processes the image 302 to determine an alpha channel associated with the image 302, shown as a holdout matte 306 that is output by the alpha channel module 304 and an inverse of the alpha channel. Illustratively, the holdout matte 306, includes white pixels corresponding to a background in the image 302, black pixels corresponding to a foreground in the image 302, and various gray pixels that indicate semi-transparency at boundaries between the foreground and background. Optionally, the compositing application 246 can invert the holdout matte 306 to generate an alpha matte (not shown). As shown, the alpha channel module 304 can also generate a foreground image 308 in which the background from the image 302 has been replaced with black.

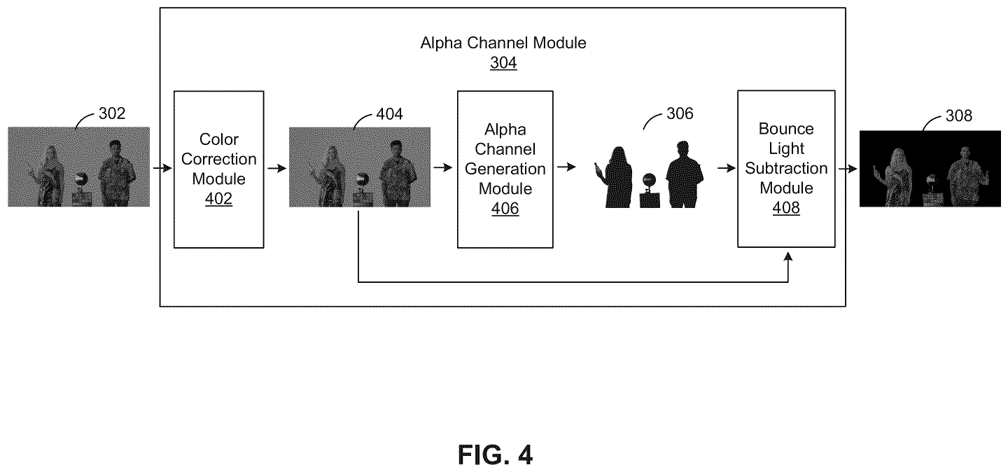

FIG. 4 is a more detailed illustration of the alpha channel module 304 of FIG. 3, according to various embodiments. As shown, the alpha channel module 304 includes a color correction module 402, an alpha channel generation module 406, and a bounce light subtraction module 408. In operation, the alpha channel module 304 receives the image 302 that includes a magenta foreground and a green background as input. Given the image 302, the color correction module 402 removes color crosstalk in the image 302 to generate a color-corrected image 404. The color crosstalk can result from the design of a digital camera (e.g., camera 110) that captured the image 302. Digital cameras typically sense color by placing a color filter array, such as a Bayer pattern, over a set of photosites that are sensitive to the entirety of the visible spectrum. The color filters can have a significant degree of overlap in spectral transmission. For example, a given wavelength of red light may register on both the red and green color channels of an image, a phenomenon referred to as “crosstalk.” In some embodiments, the color correction module 402 can remove crosstalk using a 3×3 color transformation matrix M that is determined during color calibration and prior to capturing of the image 302. During the color calibration, the appearance of each of the LED spectra to the camera 110 can be recorded by placing a color chart within a scene being captured by the camera 110 and illuminating the color chart consecutively by red, green, and blue light. Then, the average red, green, blue (RGB) color of the white square in the color chart under each lighting condition can be computed and placed as column vectors into a measurement matrix W. Such a measurement matrix records how much of each LED color affects each color channel. Since W transforms the individual LED colors to camera observations, M=W⁻¹ transforms camera observations back to the individual LED colors, removing the crosstalk. Accordingly, the color correction module 402 can apply the color calibration matrix M to the image 302 to generate the color-corrected image 404, which is similar to an image that was captured using a camera with “sharp” spectral sensitivities without color channel crosstalk.

The alpha channel generation module 406 takes as input the color-corrected image 404 and outputs the holdout matte 306. As described, the holdout matte 306 is an inverse of the alpha channel that includes white pixels corresponding to a background in the image 302, black pixels corresponding to a foreground in the image 302, and various gray pixels that indicate semi-transparency at boundaries between the foreground and background. In some embodiments, the alpha channel generation module 406 can generate the holdout matte 306 by taking the background (green) color values in the pre-processed image 408 to be the monochromatic alpha channel, which essentially converts the background color values to grayscale values of the holdout matte 306.

More formally, let the background color of a pixel be denoted by the RGB triple [B_{R}, B_{G}, B_{B}], the foreground subject of the pixel be denoted by [F_{R}, F_{G}, F_{B}], and the composited appearance of the pixel be denoted by [C_{R}, C_{G}, C_{B}]. Assuming a single alpha transparency α for all color channels, the matting equations are:

$${C}_{R} = α {F}_{R} + ( 1 - α ) {B}_{R} \qquad ( 1 )$$

$${C}_{G} = α {F}_{G} + ( 1 - α ) {B}_{G}$$

$${C}_{B} = α {F}_{B} + ( 1 - α ) {B}_{B} .$$

It should be noted the matting equations (1) include seven total unknowns for a given image: B_{R}, B_{G}, B_{B}, F_{R}, F_{G}, F_{B}, α, as the pixel values of the image include C_{R}, C_{G}, C_{B}. In cases where the background color B_{R}, B_{G}, B_{B} can be measured (e.g., by photographing a clean plate without the foreground subject) there are four unknowns: F_{R}, F_{G}, F_{B}, α. If a foreground subject reflects no blue light, then F_{B}=0, and the blue channel of the subject in front of a blue screen gives a direct measurement of 1−α, which allows F_{R}, F_{G}, and a to be determined easily. The system 100, described above in conjunction with FIG. 1, permits turning off the LEDs of a particular color (e.g., green) lighting an arbitrary subject to force F_{G}=0 and illuminating the subject from behind with a field of the particular light (e.g., a field of green light). In this way,

$${C}_{R} = α {F}_{R} + ( 1 - α ) {B}_{R} \qquad ( 2 )$$

$${C}_{G} = ( 1 - α ) {B}_{G}$$

$${C}_{B} = α {F}_{B} + ( 1 - α ) {B}_{B} .$$

Rearranging the equations (2) to solve for the three remaining unknowns yields

$$α = \frac{{B}_{G} - {C}_{G}}{{B}_{G}} \qquad ( 3 )$$

$${F}_{R} = \frac{{C}_{R} - ( 1 - α ) {B}_{R}}{α}$$

$${F}_{B} = \frac{{C}_{B} - ( 1 - α ) {B}_{B}}{α} .$$

It should be noted the equations (3) are solvable only if B_{G}>0, as otherwise the first equation is undefined. Furthermore, if a is zero, the foreground colors F_{R} and F_{B} are undefined. The intuition behind the equations (3) is that the background color (e.g., green) channel is guaranteed only to be nonzero in the background, and so the background color channel is essentially just a silhouette image of the subject, with pixel values of zero everywhere in the foreground. Accordingly, the background color channel is the inverse of the alpha channel, up to a scale factor. Although in equation (3) the foreground is guaranteed to have F_{G}=0, F_{R}=0, or F_{B}=0 (or another color being zero) could instead have been chosen.

The bounce light subtraction module 408 takes as input the color-corrected image 404 and the holdout matte 306. Given such inputs, the bounce light subtraction module 408 generates the foreground image 308. As used herein, bounce light refers to light from the foreground that has reflected onto the background. As a result of bounce light, the foreground will not be seen against a perfect field of black, as is required for the foreground to be self-matting with a premultiplied alpha, but rather against a field of dim reflected foreground light. In some embodiments, the bounce light can be determined during calibration prior to capturing of the image 302. For example, for the LED volume 102 of FIG. 1, bounce light can be measured during calibration by turning off the background LED panels while those LED panels are being illuminated by foreground lighting. Using the bounce light determined during calibration, bounce light subtraction module 408 can subtract the bounce light from the background of the color-corrected image 404 after removing the green color from the color-corrected image 404. In some embodiments, the bounce light subtraction module 408 can subtract the bounce light multiplied by the holdout matte 306. Doing so generates the foreground image 308 in which a foreground appears seen against perfect black (rather than the very faint magenta that is actually captured), without removing color from the foreground.

Returning to FIG. 3, the foreground image 308, which as described is generated by the alpha channel module 304, can be input into the colorization model 250. Given the foreground image 308 as input, the colorization model 250 outputs a colorized foreground image 312 in which the green channel that is missing from the foreground image 308 has been predicted by the colorization model 250. In some embodiments, the colorization model 250 is a deep neural network, such as a convolutional neural network, that is trained to infer the background color (e.g., the green channel) from the foreground color (e.g., the red and blue channels when the foreground is magenta). For example, in some embodiments, the colorization model 250 can be an image-to-image translation neural network having a U-Net architecture. As a specific example, the U-Net could include two 3×3 convolutional layers followed by five downsampling blocks, starting with 32 channels and doubling the number at each layer, five upsampling blocks with corresponding numbers of channels, two additional 3×3 convolutions, and a final 1×1 convolution and tanh nonlinearity to constrain the output pixel values to a reasonable range. In such cases, a Leaky ReLU non-linearity and Batch Normalization can be used after each convolution layer except for the first two convolution layers. In addition, each downsampling and upsampling block can include two 3×3 convolutions and use blur-pooling.

The compositing module 314 takes the colorized foreground image 312 and the holdout matte 306 as inputs, and the compositing module 314 generates the composite image 316 in which the background in the colorized foreground image 312, as indicated by the holdout matte 306, has been replaced by a portion of another image, shown as an image of an outdoor scene. The compositing module 314 can perform any technically feasible compositing, including known compositing techniques, in some embodiments.

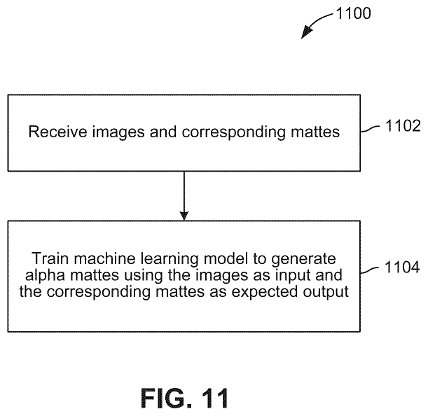

In addition to generating composite images, alpha channels and/or holdout mattes (e.g., holdout matte 306) that are generated by the alpha channel module 304 can be used, along with corresponding images, to train a machine learning model to output alpha channels (or holdout mattes) given input images. As discussed in greater detail below in conjunction with FIG. 11, such a machine learning model can be trained using (1) standalone images and/or frames of videos of multiple individuals against different backgrounds, wearing different outfits, moving at different rates, holding different objects, under different lighting conditions, etc.; and (2) corresponding alpha channels (or holdout mattes). The trained machine learning model can be deployed for use in any suitable application, such a videoconferencing application, an image or video editing application, or the like.

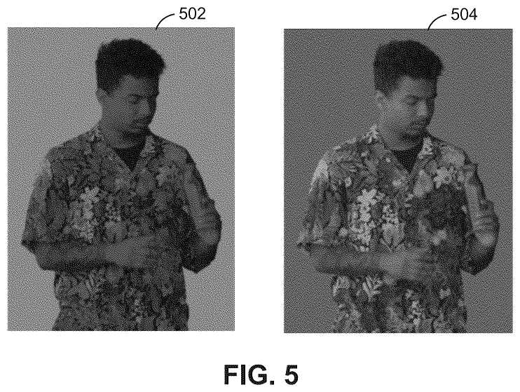

In some embodiments, when videos are captured using the system 100 described above in conjunction with FIG. 1, the videos can include time-multiplexed video frames that rapidly switch between (1) video frames having a particular color foreground lighting and a complement color background, and (2) video frames having the complement color foreground lighting and the particular color background, which integrate to normal lighting such that the different foreground and background colors in each video frame are imperceptible to individuals. FIG. 5 illustrates exemplar time-multiplexed video frames, according to various embodiments. As shown, in a time-multiplexed video, each frame having a foreground that is a particular color and a background that is a complement color can be immediately followed by a frame having a foreground that is the complement color and a background that is the particular color. Illustratively, a video frame 502 that includes a magenta foreground and a green background is immediately followed by a video frame 504 that includes a green foreground and a magenta background. In some embodiments, a time-multiplexed video can be captured at 48 fps, with each video frame (e.g., video frames 502 and 504) being captured at a rate of one video frame per 1/144^{th} of a second.

In some embodiments, given time-multiplexed video frames, such as the video frames 502 and 504, a set of the video frames that includes one color foreground lighting and a complement color background can be used to generate an alpha channel (and/or holdout matte) and composite image, as described above in conjunction with FIG. 3-4. In such cases, the remaining video frame from the time-multiplexed video frames can be discarded. It should be noted that the shutter speed for capturing such video frames will be significantly shortened, such that motion blur is reduced in the captured video frames. In some embodiments, motion blur can be added back to a composite image using any technically feasible techniques for adding motion blur, such as known techniques that generate synthetic motion blur based on optical flow. In some other embodiments, time-multiplexed video frames can be used to colorize a set of the video frames that includes one color foreground lighting and a complement color background using the other video frames that include the opposite foreground light and background and optical flow to align the different video frames. However, experience has shown that such colorization can produce more artifacts than colorization using the colorization model 250, particularly when there is significant motion blur and/or movement in the video frames being colorized.

FIG. 6 is a more detailed illustration of the model trainer 216 of FIG. 2, according to various embodiments. As shown, the model trainer 216 includes a decomposition module 604 and a training module 610. In operation, the decomposition module 604 decomposes an input image 602 into (1) an image 606 that includes one color, shown as magenta, from the image 602; and (2) another image 608 that includes a complement color, shown as green, from the image 602. Although one image 602 is shown for illustrative purposes, in some embodiments, any number of images can be decomposed and used to train the colorization model 250. Further, image 602 can be a standalone image or a frame of a video. For example, prior to capturing a scene with magenta foreground lighting and a green background, the same scene can be captured during a rehearsal take using white foreground lighting and a black background. Video frames from the rehearsal take can then be input into the model trainer 216 (e.g., as the image 602) for training the colorization model 250.

Illustratively, the training module 610 takes the images 606 and 608 as input and trains a colorization model 250 using the images 606 and 608 as training data. In some embodiments, the training module 610 uses the image 606 as the model input and the image 608 as the expected output during training. In some embodiments, any technically feasible training technique can be employed by the training module 610, such as backpropagation with gradient descent or a variation thereof. For example, in some embodiments, the Adam optimizer can be used during training. In some embodiments, the colorization model 250 can either be trained from scratch or trained by fine-tuning a pre-trained model for a particular scene, with the pre-trained model having been previously trained on other images of the world. In some embodiments, data augmentation can also be employed, such as by generating croppings of the input image 602 and randomly perturbing the image luminance and color balance in the croppings.

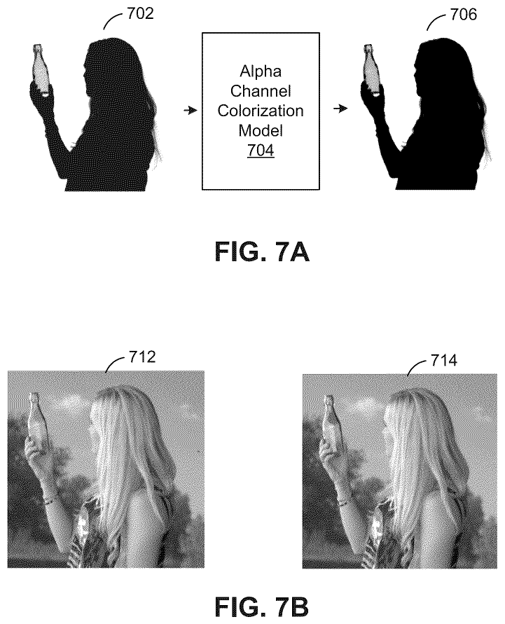

FIG. 7A illustrates a machine learning model that colorizes mattes, according to various embodiments. As shown, an alpha channel colorization model 704 takes as input an alpha channel associated with an image, shown as a holdout matte 702 that is the inverse of the alpha channel. Given such an input, the alpha channel colorization model 704 outputs a colorized version of the alpha channel, shown as a holdout matte 706 indicating the colorful transparency of a bottle. The alpha channel may need to be colorized when some objects that have colorful transparency transmit certain colors more than others, such as due to tinting on the bottle. In some embodiments, the alpha channel colorization model 704 can be a machine learning model having the same architecture, and trained in a similar manner, as the colorization model 250, described above in conjunction with FIGS. 3 and 6. In such cases, training images for training the alpha channel colorization model 704 can be obtained by capturing the object(s) in the foreground backlit with white light. For example, a reference video of actors performing while silhouetted in front of a white background can be captured during a rehearsal take, and frames from the reference video can be used to train the alpha channel colorization model 704. In some embodiments, to aid the alpha channel colorization model 704 in matte colorization, RGB channels of a frame prior to an input monochrome matte can be provided as an additional signal, and such training data can be obtained by multiplexing the silhouetted lighting with white lighting over a black background. In some embodiments, the alpha channel colorization model 704 can be used by the alpha channel module 304, described above in conjunction with FIG. 3, to colorize mattes (or holdout mattes).

FIG. 7B illustrates exemplar composite images generated using the holdout mattes 702 and 706 of FIG. 7A, according to various embodiments. As shown, a composite image 712 was generated using the holdout matte 702, and a composite image 714 was generated using the holdout matte 706. Illustratively, the composite image 714 includes a better color rendition of a bottle than the composite image 712.

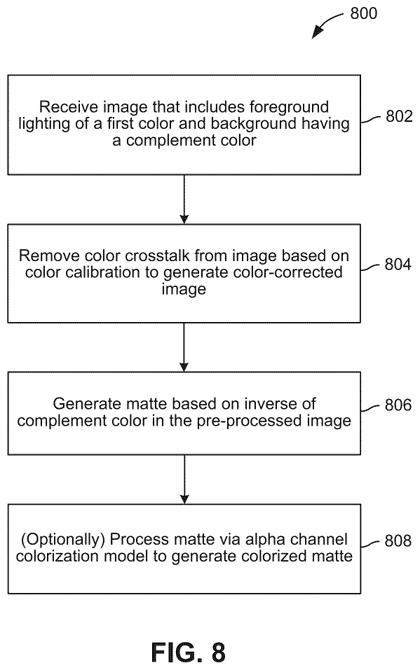

FIG. 8 is a flow diagram of method steps for generating a matte, according to various embodiments. Although the method steps are described with reference to the systems of FIGS. 1-4 and 6-7, persons skilled in the art will understand that any system configured to implement the method steps, in any order, falls within the scope of the present disclosure.

As shown, a method 800 begins at step 802, where the compositing application 246 receives an image that includes foreground lighting of a first color and a background having a complement color of the first color. In some embodiments, the image can be captured by a camera in a system such as the system 100, described above in conjunction with FIG. 1. Although the method 800 is described with respect to one image, steps of the method 800 can be repeated to process multiple images, such as multiple frames of a video. When the video is a time-multiplexed video, every other frame, or any other number of frames that include the desired foreground lighting and background color, can be processed according to steps of the method 800.

At step 804, the compositing application 246 removes color crosstalk from the received image based on a color calibration to generate a color-corrected image. In some embodiments, the compositing application 246 removes the color crosstalk by applying, to the received image, a color calibration transformation. In such cases, the color calibration transformation can be a matrix determined during a calibration phase in which a color chart including a white square is captured while being illuminated separately by red, blue, and green light, as described above in conjunction with FIG. 4.

At step 806, the compositing application 246 generates a matte (i.e., alpha channel) based on an inverse of the complement color in the pre-processed image. In addition or alternatively, the compositing application 246 can generate a holdout matte based on the complement color in the pre-processed image. As described, a holdout matte can be generated by taking the background (green) color values in the pre-processed image to be the monochromatic alpha channel, which essentially converts the background color values into grayscale values of the holdout matte. A matte can be obtained by inverting the holdout matte.

At step 808, the compositing application 246 optionally processes the matte via the alpha channel colorization model 704 to generate a colorized matte. As described above in conjunction with FIG. 7, the alpha channel colorization model 704 is trained to output a colorized version of an input matte.

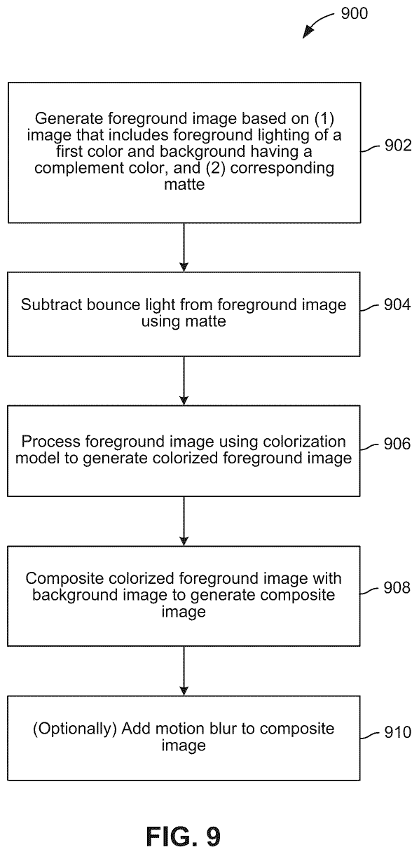

FIG. 9 is a flow diagram of method steps for generating a composite image, according to various embodiments. Although the method steps are described with reference to the systems of FIGS. 1-4 and 6-7, persons skilled in the art will understand that any system configured to implement the method steps, in any order, falls within the scope of the present disclosure.

As shown, a method 900 begins at step 902, where the compositing application 246 generates a foreground image based on (1) an image that includes foreground lighting of a first color and background having a complement color, and (2) a corresponding matte. The compositing application 246 can generate the foreground image by removing the background, as indicated by the matte, from the image.

At step 904, the compositing application 246 subtracts bounce light from the foreground image. In some embodiments, bounce light that was previously measured during calibration is multiplied by the holdout matte, and the result is subtracted from the foreground image at step 904.

At step 906, the compositing application 246 processes the foreground image (from which bounce light has been subtracted) using the colorization model 250 to generate a colorized foreground image. As described above in conjunction with FIG. 3, given an image that includes one color (e.g., magenta) as input, the colorization model 250 is trained to output a colorized version of the image that also includes a complement color (e.g., green).

At step 908, the compositing application 246 composites the colorized foreground image with a background image to generate a composite image. Any technically feasible compositing, including known compositing techniques, can be performed in some embodiments.

At step 910, the compositing application 246 optionally adds motion blur to the composite image. Any technically feasible techniques for adding motion blur, including known techniques that generate synthetic motion blur based on optical flow, can be performed in some embodiments.

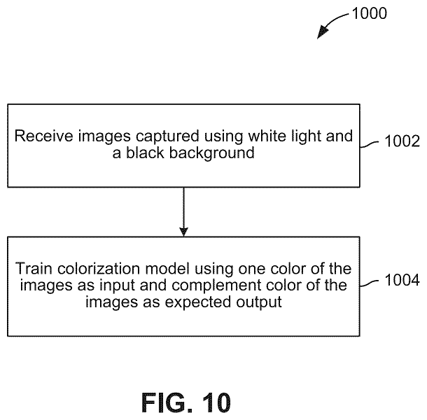

FIG. 10 is a flow diagram of method steps for training a colorization model, according to various embodiments. Although the method steps are described with reference to the systems of FIGS. 1-4 and 6-7, persons skilled in the art will understand that any system configured to implement the method steps, in any order, falls within the scope of the present disclosure.

As shown, a method 1000 begins at step 1002, where the model trainer 216 receives images captured using white light and a black background.

At step 1004, the model trainer 216 trains the colorization model 250 using one color of the images as input and a complement color of the images as expected output. Any technically feasible training techniques, such as the training techniques described above in conjunction with FIG. 6, can be used to train the colorization model 250 in some embodiments.

FIG. 11 is a flow diagram of method steps for training a machine learning model to generate mattes for images, according to various embodiments. Although the method steps are described with reference to the systems of FIGS. 1-4 and 6-7, persons skilled in the art will understand that any system configured to implement the method steps, in any order, falls within the scope of the present disclosure.

As shown, a method 1100 begins at step 1102, where the model trainer 216 receives images and corresponding mattes. In some embodiments, the mattes can be generated for the images according to the method 800 described above in conjunction with FIG. 8. In some embodiments, the images can include standalone images and/or frames of videos of multiple individuals against different backgrounds, wearing different outfits, moving at different rates, holding different objects, under different lighting conditions, etc.

At step 1104, the model trainer 216 trains a machine learning model to generate mattes using the images as input and the corresponding mattes as expected output. Any suitable machine learning model, such as a deep neural network, can be trained in some embodiments. Any technically feasible training techniques, such as backpropagation with gradient descent or a variant thereof, can be used in some embodiments. Subsequent to training, the trained machine learning model can be deployed for use in any suitable application, such a videoconferencing application, an image or video editing application, or the like.

In sum, techniques are disclosed for determining alpha channels for images. In some embodiments, an image, which can be a standalone image or a frame of a video, is captured using foreground lighting of a particular color and a background having a complement color. The image is pre-processed to correct for color crosstalk. The complement color in the pre-processed image is converted to grayscale to generate a holdout matte, which can be inverted to obtain the alpha channel (i.e., matte) that indicates pixels of the image belonging to the foreground and/or background. Bounce light is also removed by subtracting the bounce light, which can be determined during calibration, multiplied by the holdout matte. Then, a trained machine learning model can be applied to convert a foreground of the image having the particular color into a colorized foreground image that also includes the complement color. The colorized foreground image can then be composited with an image of another background. In addition, the image and corresponding alpha channel can be used to train a machine learning model to predict an alpha channel given an image.

At least one technical advantage of the disclosed techniques relative to the prior art is that the disclosed techniques can be used to generate relatively high quality mattes for images, without requiring the use of any complex matting algorithms or requiring the manual tuning of any algorithm parameters. Accordingly, the disclosed techniques can be more computationally efficient and less labor intensive than prior art approaches. In addition, the disclosed techniques utilize images captured by a single camera rather than images captured by two separate cameras where the resulting images need to be precisely aligned with each other. Thus, the disclosed techniques can be more accurate and can generate images without artifacts resulting from misalignments relative to what can be achieved using prior art approaches. These technical advantages represent one or more technological improvements over prior art approaches.
1. In some embodiments, a computer-implemented method for generating mattes for images comprises receiving an image that includes a foreground having a first color and a background having a second color, wherein the second color is a complement of the first color, and generating a matte based on the second color included in the image.
2. The computer-implemented method of clause 1, further comprising generating a foreground image based on the image and the matte, and processing the foreground image via a trained machine learning model to generate a colorized foreground image that includes the second color.
3. The computer-implemented method of clauses 1 or 2, further comprising generating a composite image based on the colorized foreground image and an image of another background.
4. The computer-implemented method of any of clauses 1-3, further comprising computing an optical flow based on the image and one or more other images, and performing one or more operations to add motion blur to the composite image based on the optical flow.
5. The computer-implemented method of any of clauses 1-4, further comprising training, based on at least one first channel corresponding to the first color from one or more images and at least one second channel corresponding to the second color from the one or more images, a machine learning model to generate the trained machine learning model.
6. The computer-implemented method of any of clauses 1-5, further comprising performing one or more operations to reduce color crosstalk in the image based on a predetermined color calibration transformation.
7. The computer-implemented method of any of clauses 1-6, further comprising subtracting a predetermined bounce light from the image based on the matte.
8. The computer-implemented method of any of clauses 1-7, further comprising training a machine learning model based on the image and the matte.
9. The computer-implemented method of any of clauses 1-8, wherein the second color is one of green, blue, or red, and the first color is one of magenta, yellow, or cyan.
10. The computer-implemented method of any of clauses 1-9, wherein the matte comprises one of an alpha matte or a holdout matte.
11. In some embodiments, a system comprises at least one first light source configured to emit light having a first color, a background having a second color that is a complement of the first color, and a camera configured to capture at least a portion of the background and at least a portion of one or more objects illuminated by the at least one first light source.
12. The system of clause 11, wherein the background comprises at least one second light source configured to emit light having a second color.
13. The system of clauses 11 or 12, wherein the at least one first light source includes at least one light-emitting diode (LED) panel.
14. The system of any of clauses 11-13, wherein the at least one LED panel is included in an LED volume that comprises a plurality of LED panels.
15. The system of any of clauses 11-14, wherein the second color is one of green, blue, or red, and the first color is one of magenta, yellow, or cyan.
16. The system of any of clauses 11-15, wherein the at least one first light source is further configured to emit light having the second color alternatively with emitting the light having the first color.
17. The system of any of clauses 11-16, wherein the camera comprises a digital camera.
18. In some embodiments, one or more non-transitory computer-readable media store instructions that, when executed by at least one processor, cause the at least one processor to perform steps comprising receiving an image that includes a foreground having a first color and a background having a second color, wherein the second color is a complement of the first color, and generating a matte based on the second color included in the image.
19. The one or more non-transitory computer-readable media of clause 18, wherein the instructions, when executed by the at least one processor, further cause the at least one processor to perform the steps of generating a foreground image based on the image and the matte, and processing the foreground image via a trained machine learning model to generate a colorized foreground image that includes the second color.
20. The one or more non-transitory computer-readable media of clauses 18 or 19, wherein the instructions, when executed by the at least one processor, further cause the at least one processor to perform the step of performing one or more operations to at least one of (i) reduce color crosstalk in the image based on a predetermined color calibration transformation, or (ii) subtract a predetermined bounce light from the image based on the matte.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating mattes for images, the method comprising:
receiving an image that includes a foreground having a first color and a background having a second color, wherein the second color is a complement of the first color; and
generating a matte based on the second color included in the image.

2. The computer-implemented method of claim 1, further comprising:
generating a foreground image based on the image and the matte; and
processing the foreground image via a trained machine learning model to generate a colorized foreground image that includes the second color.

3. The computer-implemented method of claim 2, further comprising generating a composite image based on the colorized foreground image and an image of another background.

4. The computer-implemented method of claim 3, further comprising:
computing an optical flow based on the image and one or more other images; and
performing one or more operations to add motion blur to the composite image based on the optical flow.

5. The computer-implemented method of claim 2, further comprising training, based on at least one first channel corresponding to the first color from one or more images and at least one second channel corresponding to the second color from the one or more images, a machine learning model to generate the trained machine learning model.

6. The computer-implemented method of claim 1, further comprising performing one or more operations to reduce color crosstalk in the image based on a predetermined color calibration transformation.

7. The computer-implemented method of claim 1, further comprising subtracting a predetermined bounce light from the image based on the matte.

8. The computer-implemented method of claim 1, further comprising training a machine learning model based on the image and the matte.

9. The computer-implemented method of claim 1, wherein the second color is one of green, blue, or red, and the first color is one of magenta, yellow, or cyan.

10. The computer-implemented method of claim 1, wherein the matte comprises one of an alpha matte or a holdout matte.

11. A system, comprising:
at least one first light source configured to emit light having a first color;
a background having a second color that is a complement of the first color; and
a camera configured to capture at least a portion of the background and at least a portion of one or more objects illuminated by the at least one first light source.

12. The system of claim 11, wherein the background comprises at least one second light source configured to emit light having a second color.

13. The system of claim 11, wherein the at least one first light source includes at least one light-emitting diode (LED) panel.

14. The system of claim 13, wherein the at least one LED panel is included in an LED volume that comprises a plurality of LED panels.

15. The system of claim 11, wherein the second color is one of green, blue, or red, and the first color is one of magenta, yellow, or cyan.

16. The system of claim 11, wherein the at least one first light source is further configured to emit light having the second color alternatively with emitting the light having the first color.

17. The system of claim 11, wherein the camera comprises a digital camera.

18. One or more non-transitory computer-readable media storing instructions that, when executed by at least one processor, cause the at least one processor to perform steps comprising:
receiving an image that includes a foreground having a first color and a background having a second color, wherein the second color is a complement of the first color; and
generating a matte based on the second color included in the image.

19. The one or more non-transitory computer-readable media of claim 18, wherein the instructions, when executed by the at least one processor, further cause the at least one processor to perform the steps of:
generating a foreground image based on the image and the matte; and
processing the foreground image via a trained machine learning model to generate a colorized foreground image that includes the second color.

20. The one or more non-transitory computer-readable media of claim 18, wherein the instructions, when executed by the at least one processor, further cause the at least one processor to perform the step of performing one or more operations to at least one of (i) reduce color crosstalk in the image based on a predetermined color calibration transformation, or (ii) subtract a predetermined bounce light from the image based on the matte.
